(19) United States
(12) Patent Application Publication
(10) Pub. No.: US 2009/0204512 A1
(43) Pub. Date: Aug. 13, 2009

(54) METHOD AND SYSTEM FOR DETERMINING A RESTOCKING STATE OF A PRODUCT

(76) Inventors: Jonathan H. Connell, II, Cortlandt-Manor, NY (US); Arun Hampapur, Norwalk, CT (US)

Correspondence Address: HOFFMAN WARNICK LLC, 75 STATE ST, 14TH FLOOR, ALBANY, NY, 12207, US

(21) Appl. No.: 12/029,027

(22) Filed: Feb. 11, 2008

(51) Int. Cl. G06Q 10/00

(52) U.S. Cl. 705/28

(57) ABSTRACT

The present invention is directed to a method and system for determining a restocking state of a product in a retail store. A method in accordance with an embodiment includes: acquiring an image of a current state of a product at an assigned shelf location; determining a remaining number of the product at the assigned shelf location based on the acquired image; comparing the remaining number of the product at the assigned shelf location to a predetermined restocking level for the product; and generating a restocking alert if the remaining number of the product at the assigned shelf location is less than the predetermined restocking level for the product.

### FIELD OF THE INVENTION

The present invention relates to imaging systems, and more specifically relates to a method and system for determining a restocking state of a product (e.g., in a retail store).

### BACKGROUND OF THE INVENTION

It is important to know when a product is no longer available on a shelf in a retail store. If there is no product available, sales and customer satisfaction will decrease.

Retail store personnel will typically walk the aisles of a retail store and dispatch stock clerks to replenish items deemed to be in low supply on the shelves of the store. This is a very labor intensive process, which requires continued vigilance on the part of store personnel.

An alternative to the above-described process involves the counting of each item on a shelf and comparing this number to sales receipts. If a shelf holds, for example, 50 boxes of cereal of brand XYZ, and 42 boxes have been sold over the last 3 hours, then an employee should be sent to restock the appropriate shelf. Unfortunately point-of-sale (POS) cash-register data may not accurately reflect shelf state. For instance, customers often pick up items and continue wandering the store for an extended period of time. In this case, a shelf may become empty before it can be detected using sales receipts. Further, over longer time spans, sales may not accurately reflect shelf emptiness due to “shrinkage” (e.g., items are sometimes picked up then deposited elsewhere in the store without purchasing, or are stolen).

Accordingly, there is a need for a solution that addresses these and other deficiencies of the related art.

### SUMMARY OF THE INVENTION

The present invention is directed to a method and system for determining a restocking state of a product.

A first aspect is directed to a method for determining a restocking state of a product, comprising: acquiring an image of a current state of a product at an assigned shelf location; determining a remaining number of the product at the assigned shelf location based on the acquired image; comparing the remaining number of the product at the assigned shelf location to a predetermined restocking level for the product; and generating a restocking alert if the remaining number of the product at the assigned shelf location is less than the predetermined restocking level for the product.

A second aspect is directed to a system for determining a restocking state of a product, comprising: a system for acquiring an image of a current state of a product at an assigned shelf location; a system for determining a remaining number of the product at the assigned shelf location based on the acquired image; a system for comparing the remaining number of the product at the assigned shelf location to a predetermined restocking level for the product; and a system for generating a restocking alert if the remaining number of the product at the assigned shelf location is less than the predetermined restocking level for the product.

A third aspect is directed to a program product stored on a computer readable medium, which when executed, determines a restocking state of a product, the computer readable medium comprising program code for: acquiring an image of a current state of a product at an assigned shelf location; determining a remaining number of the product at the assigned shelf location based on the acquired image; comparing the remaining number of the product at the assigned shelf location to a predetermined restocking level for the product; and generating a restocking alert if the remaining number of the product at the assigned shelf location is less than the predetermined restocking level for the product.

A fourth aspect is directed to a retail store, comprising: a plurality of different products, wherein each of the plurality of different products has an assigned shelf location within the retail store; and a system for determining a restocking state of each of the plurality of different products, the system for determining comprising: a system for acquiring an image of a current state of the product at its assigned shelf location; a system for determining a remaining number of the product at the assigned shelf location based on the acquired image; a system for comparing the remaining number of the product at the assigned shelf location to a predetermined restocking level for the product; and a system for generating a restocking alert if the remaining number of the product at the assigned shelf location is less than the predetermined restocking level for the product

A fifth aspect is directed to a method for deploying an application for determining a restocking state of a product, comprising: providing a computer infrastructure being operable to: acquire an image of a current state of a product at an assigned shelf location; determine a remaining number of the product at the assigned shelf location based on the acquired image; compare the remaining number of the product at the assigned shelf location to a predetermined restocking level for the product; and generate a restocking alert if the remaining number of the product at the assigned shelf location is less than the predetermined restocking level for the product.

The illustrative aspects of the present invention are designed to solve the problems herein described and other problems not discussed.

### BRIEF DESCRIPTION OF THE DRAWINGS

These and other features of the present invention will be more readily understood from the following detailed description taken in conjunction with the accompanying drawings.

FIG. 1 depicts an illustrative system for determining a restocking state of a product in a retail store in accordance with an embodiment of the present invention.

FIGS. 2A and 2B depict an illustrative image capture/analysis process carried out by the system of FIG. 1.

FIG. 3 depicts an illustrative graph of current stock level data for a product in accordance with an embodiment of the present invention.

FIG. 4 depicts a flow diagram of an illustrative process for determining a restocking state of a product in a retail store in accordance with an embodiment of the present invention.

FIG. 5 depicts an illustrative environment for implementing embodiment(s) of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As detailed above, the present invention is directed to a method and system for determining a restocking state of a product.

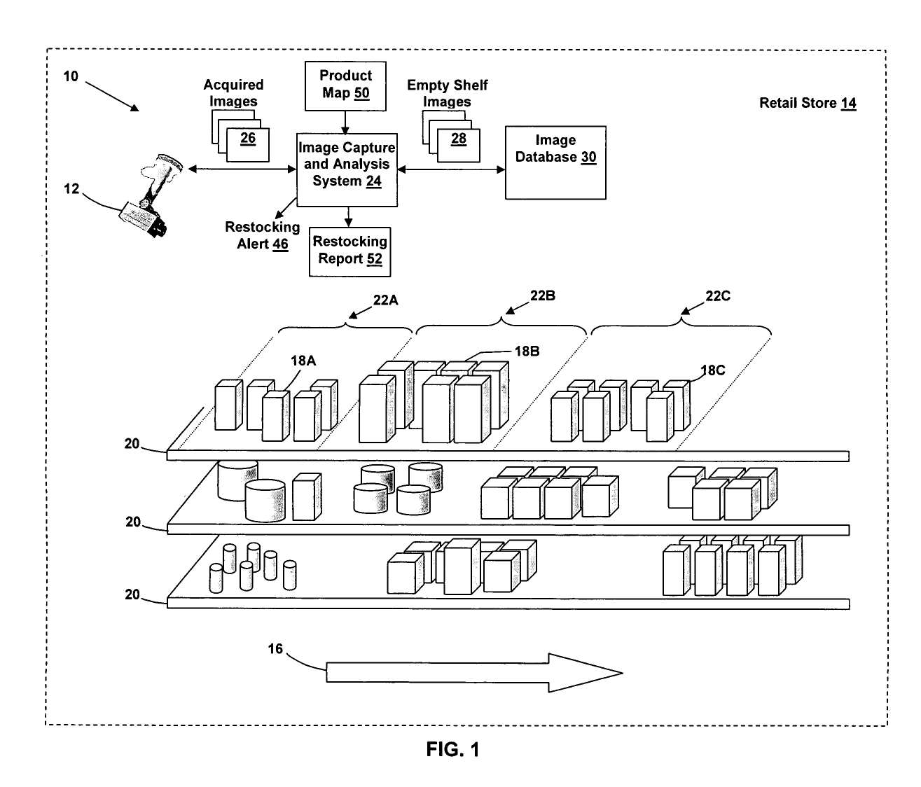

FIG. 1 depicts an illustrative system 10 for determining a restocking state of a product in a retail store 14 in accordance with an embodiment of the present invention. In general, a plurality of video cameras are used to automatically estimate the restocking state of the products on the shelves of a retail store. Shelf status is monitored in real-time, despite customer perambulations, and is immune to potential inaccuracies caused by shrinkage.

As illustrated in FIG. 1, the system 10 comprises at least one video camera, for example, a pan-tilt-zoom (PTZ) video camera 12. Each PTZ camera 12 is strategically positioned within the retail store 14 (e.g., at an end of an aisle 16, at the middle of an aisle 16, etc.), in order to capture close-up images of a plurality of different products 18 located on one or more shelves 20 in the retail store 14. Each PTZ camera 12 is capable of side to side movement (pan), up and down movement (tilt), and can zoom in and out (zoom). A single PTZ camera 12 is depicted in FIG. 1 for clarity of illustration. The operation of PTZ cameras is assumed to be within the purview of one skilled in the art and will not be discussed in detail herein. Other suitable types of video cameras can also be used to acquire images for use in the present invention.

The PTZ camera 12 monitors the restocking state of a predetermined number of different products 18 on the shelves 20 of the retail store 14. Each product 18 is assigned a different shelf location 22. For example, in FIG. 1, the product 18A has been assigned the shelf location 22A, the product 18B has been assigned the shelf location 22B, the product 18C has been assigned the shelf location 22C, etc. The PTZ camera 12 is configured, under control of an image capture and analysis system 24, to periodically acquire an image 26 of the current state of each monitored product 18 at its assigned shelf location 22. The acquired image 26 of the assigned shelf location 22 of each monitored product 18 is provided to the image capture and analysis system 24, which compares the acquired image 26 to a corresponding “empty” shelf image 28 of the product's assigned shelf location 22 to determine how much of the product 18 is/remains in the assigned shelf location 22, and/or whether the assigned shelf location 22 is empty. The empty shelf images 28 can be stored, for example, in an image database 30. This comparison can be performed using any suitable methodology including, for example, background subtraction (BGS) or other suitable technique. BGS detects regions of change by comparing a current image against a reference image (e.g., the “empty” shelf image 28). Alternatively, differing characteristics of the shelf location 22 versus the product 18 (e.g., textured vs. bland, bright red vs. gray, etc.) can be determined.

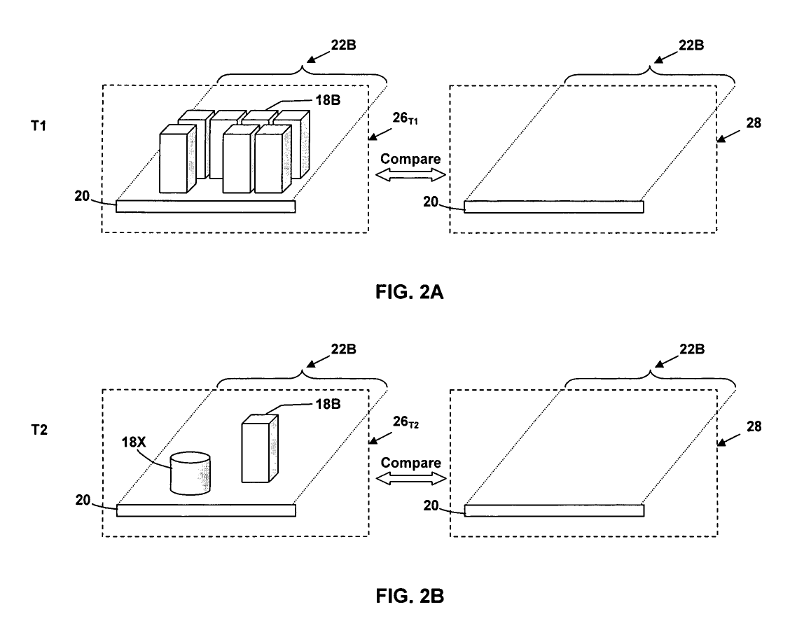

An example of the above-described image capture/analysis process is depicted in FIGS. 2A and 2B. In FIG. 2A, a first acquired image 26_{T1} of the shelf location 22B is obtained by the PTZ camera 12 (FIG. 1) at a time T1. Upon comparing the acquired image 26_{T1} to a corresponding “empty” shelf image 28 for the shelf location 22B, the image capture and analysis system 24 determines that seven (7) of the products 18B are present at the shelf location 22B at time T1. In FIG. 2B, a second acquired image 26_{T2} of the shelf location 22B is obtained by the PTZ camera 12 at a time T2. In this case, however, upon comparing the acquired image 26_{T2} to the corresponding “empty” shelf image 28 for the shelf location 22B, the image capture and analysis system 24 determines that only one (1) product 18B is present at the shelf location 22B at time T2. The product 18X, which may have been deposited at the shelf location 22B (i.e., not at its assigned shelf location) by a customer of the retail store 14, is ignored by the image capture and analysis system 24, which is capable of differentiating between the various different products 18.

The image capture and analysis system 24 can be configured to provide a robust analysis of the acquired images 26. For example, the image capture and analysis system 24 can be configured to disregard acquired images 26 in which customers, shopping carts, boxes, etc., are obscuring a shelf, and to acquire additional images as necessary. Further, the image capture and analysis system 24 can be configured to be tolerant to slight image mis-registrations and lighting changes.

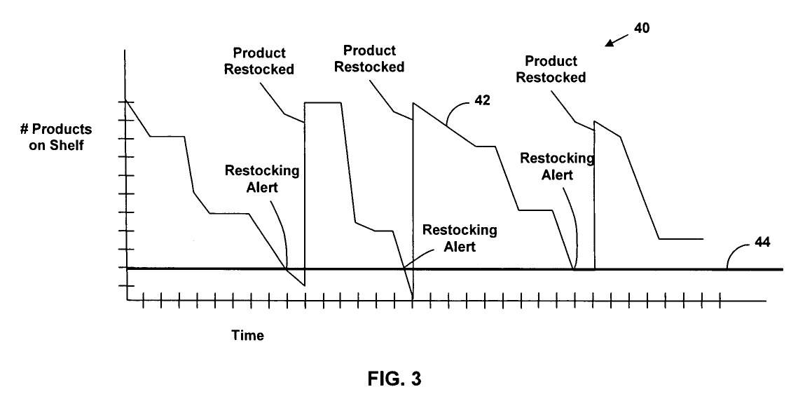

The image capture and analysis system 24 periodically monitors the amount of each product 18 that is present at its assigned shelf location 22, and generates current stock level data for the product 18. A graph 40 of the current stock level data 42 for a product 18 is depicted in FIG. 3. As shown, the current stock level data 42 for the product 18 varies as the product 18 is restocked or removed from its assigned shelf location 22. When the current stock level for the product reaches a predetermined restocking level 44 for the product 18, the image capture and analysis system 24 generates a restocking alert 46 (FIG. 1). The restocking level 44 may be product specific and can be set by a user to any suitable value (e.g., shelf empty (zero products remaining), N products remaining (N>0), ½ of the products remaining, etc.) for each different product 18 in the retail store 14. For example, the restocking level 44 for a product 18Y may be ten (10), while the restocking level 44 for a different product 18Z may be one (1).

The image capture and analysis system 24 can be provided with a predefined product map 50 detailing the assigned shelf location 22 of each product 18 in the retail store 14. The image capture and analysis system 24 can use the product map 50 to generate a restocking report 52 detailing those products 18 that need to be restocked at any given time. In general, the image capture and analysis system 24 can generate: restocking alerts 46 in real time; restocking reports 52 (e.g., end of day restocking reports); longer term models of product 18 removal (e.g., what is selling well), and/or the like.

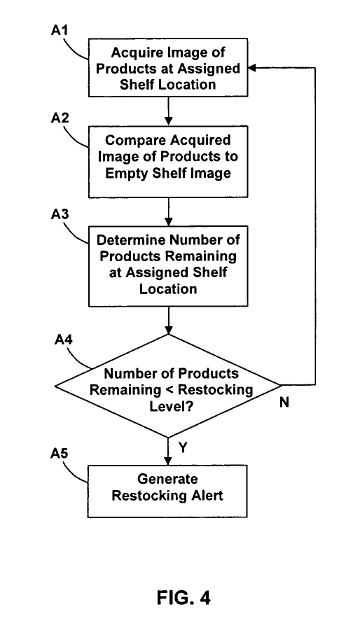

FIG. 4, taken in conjunction with FIG. 1, depicts a flow diagram of an illustrative process for determining a restocking state of a product 18 in a retail store 14 in accordance with an embodiment of the present invention. At A1, an image 26 of the current state of a monitored product 18 at its assigned shelf location 22 is acquired using the PTZ camera 12. At A2, the image capture and analysis system 24 compares the acquired image 26 of the shelf location 22 of the product 18 to a corresponding empty shelf image 28. Alternatively, differing characteristics of the shelf location 22 versus the product 18 can be determined (e.g., textured vs. bland, bright red vs. gray, etc.). At A3, the image capture and analysis system 24 determines how many of the products 18 remain in the assigned shelf location 22. At A4, the image capture and analysis system 24 compares the number of products 18 that remain to a predetermined restocking level 44 (FIG. 3). If the number of products 18 is greater than the predetermined restocking level 44 (NO, A4), flow passes back to A1. If the number of products 18 is less than the predetermined restocking level 44 (YES, A4), the image capture and analysis system 24 generates a restocking alert 46 at A5. Flow then passes back to A1.

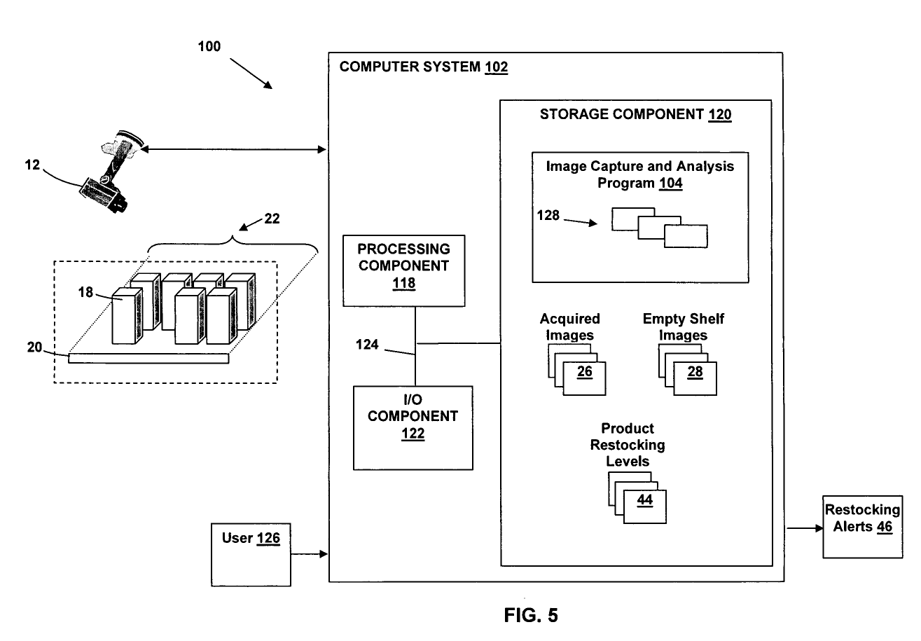

FIG. 5 shows an illustrative environment 100 for determining a restocking state of a product in accordance with any/all embodiments of the disclosure. To this extent, environment 100 includes a computer system 102 that can perform the processes described herein. For example, the computer system 102 can be configured to include a image capture and analysis program 104 for: controlling the operation of at least one PTZ camera 12; periodically acquiring an image 26 of the current state of a monitored product 18 at its assigned shelf location 22; comparing the acquired image 26 to an empty shelf image 28 to determine how many of the products 18 remain in the assigned shelf location 22; comparing the number of products 18 that remain to a predetermined restocking level 44 for that product 18; and generating a restocking alert 46 if the number of products 18 is less than the predetermined restocking level 44 for the product 18, by performing the processes described herein.

The computer system 102 is shown including a processing component 118 (e.g., one or more processors), a storage component 120 (e.g., a storage hierarchy), an input/output (I/O) component 122 (e.g., one or more I/O interfaces and/or devices), and a communications pathway 124. In general, the processing component 118 executes program code, such as the image capture and analysis program 104, which are at least partially stored in storage component 120. While executing program code, the processing component 118 can read and/or write data to/from the storage component 120 and/or the I/O component 122. The communication pathway 124 provides a communications link between each of the components in computer system 102. The I/O component 122 can comprise one or more human I/O devices, which enable a human user 126 to interact with the computer system 102, and/or one or more communications devices to enable other computer system(s) to communicate with the computer system 102 using any type of communications link.

The computer system 102 can comprise one or more general purpose computing articles of manufacture (e.g., computing devices) capable of executing program code installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, the image capture and analysis program 104 can be embodied as any combination of system software and/or application software. Further, the image capture and analysis program 104 can be implemented using a set of modules 128. In this case, a module 128 can comprise a component that performs a set of actions used by the image capture and analysis program 104. Further, it is understood that some of the actions discussed herein may not be implemented or additional actions may be implemented by computer system 102.

When the computer system 102 comprises multiple computing devices, each computing device can have only a portion of the image capture and analysis program 104 installed thereon (e.g., one or more modules 128). However, it is understood that the computer system 102 is only representative of various possible equivalent computer systems that may implement the process described herein. To this extent, in other embodiments, the actions implemented by the computer system 102 can be at least partially implemented by one or more computing devices that include any combination of general and/or specific purpose hardware and/or program code. In each embodiment, the program code and hardware can be provided using standard programming and engineering techniques, respectively.

When the computer system 102 includes multiple computing devices, the computing devices can communicate over any type of communications link. Further, while performing the process described herein, the computer system 102 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

It is understood that each of the process flows shown and described herein is only illustrative. To this extent, numerous variations of these process flows are possible, and are included within the scope of this disclosure. Illustrative variations include performing one or more processes in parallel and/or a different order, performing additional processes, not performing some processes, and/or the like. To this extent, the computer system 102 and the image capture and analysis program 104 can utilize multiple tasks/threads/processes to perform the actions of the processes described herein.

It is further understood that aspects of the invention further provide various alternative embodiments. For example, in one embodiment, the invention provides a computer program stored on at least one computer-readable medium, which when executed, enables a computer system to perform the processes described above. To this extent, the computer-readable medium can include program code, such as the image capture and analysis program 104, which implement some or all of the process described herein. It is understood that the term “computer-readable medium” comprises one or more of any type of tangible medium of expression capable of embodying a copy of the program code (e.g., a physical embodiment). For example, the computer-readable medium can comprise: one or more portable storage articles of manufacture; one or more memory/storage components of a computing device; a modulated data signal having one or more of its characteristics set and/or changed in such a manner as to encode information in the signal; paper; and/or the like.

In another embodiment, a computer system, such as the computer system 102, can be obtained (e.g., provided, created, maintained, made available, etc.) and one or more programs/systems for performing the process described herein can be obtained (e.g., provided, created, purchased, used, modified, etc.) and deployed to the computer system. To this extent, the deployment can comprise one or more of: (1) installing program code on a computing device from a computer-readable medium; (2) adding one or more computing devices to the computer system; and (3) incorporating and/or modifying the computer system to enable it to perform the process described herein.

Aspects of the invention can be also implemented as part of a business method that performs the process described herein on a subscription, advertising, and/or fee basis. That is, a service provider could offer to provide some/all of the components/processes needed to determine a restocking state of a product, as described herein. In this case, the service provider can manage (e.g., create, maintain, support, etc.) some or all of the environment 100, such as the computer system 102 and/or the image capture and analysis program 104, that performs the process described herein for one or more customers. In return, the service provider can receive payment from the customer(s) under a subscription and/or fee agreement, receive payment from the sale of advertising to one or more third parties, and/or the like.

The foregoing description of the preferred embodiments of this invention has been presented for purposes of illustration and description. It is not intended to be exhaustive or to limit the invention to the precise form disclosed, and obviously, many modifications and variations are possible.

What is claimed is:

1. A method for determining a restocking state of a product, comprising:
acquiring an image of a current state of a product at an assigned shelf location;
determining a remaining number of the product at the assigned shelf location based on the acquired image;
comparing the remaining number of the product at the assigned shelf location to a predetermined restocking level for the product; and
generating a restocking alert if the remaining number of the product at the assigned shelf location is less than the predetermined restocking level for the product.

2. The method of claim 1, wherein determining a remaining number of the product at the assigned shelf location further comprises:
comparing the acquired image to an empty shelf image of the assigned shelf location.

3. The method of claim 1, wherein the image of a current state of a product at an assigned shelf location is acquired using a pan-tilt-zoom (PTZ) video camera.

4. The method of claim 1, further comprising:
periodically repeating the acquiring, determining, and comparing; and
generating a restocking alert whenever the remaining number of the product at the assigned shelf location is less than the predetermined restocking level for the product.

5. The method of claim 1, wherein there are a plurality of different products, further comprising:
obtaining a product map detailing the assigned shelf location of each of the plurality of different products;
performing the acquiring, determining, and comparing for each of the plurality of different products; and
generating a restocking report detailing which of the plurality of different products need to be restocked.

6. The method of claim 1, wherein the assigned shelf location of the product is located in a retail store.

7. A system for determining a restocking state of a product, comprising:
a system for acquiring an image of a current state of a product at an assigned shelf location;
a system for determining a remaining number of the product at the assigned shelf location based on the acquired image;
a system for comparing the remaining number of the product at the assigned shelf location to a predetermined restocking level for the product; and
a system for generating a restocking alert if the remaining number of the product at the assigned shelf location is less than the predetermined restocking level for the product.

8. The system of claim 7, wherein the system for determining a remaining number of the product at the assigned shelf location further comprises:
a system for comparing the acquired image to an empty shelf image of the assigned shelf location.

9. The system of claim 7, wherein the image of a current state of a product at an assigned shelf location is acquired using a pan-tilt-zoom (PTZ) video camera.

10. The system of claim 7, further comprising:
a product map detailing the assigned shelf location of each of a plurality of different products; and
a restocking report detailing which of the plurality of different products need to be restocked.

11. A program product stored on a computer readable medium, which when executed, determines a restocking state of a product, the computer readable medium comprising program code for:
acquiring an image of a current state of a product at an assigned shelf location;
determining a remaining number of the product at the assigned shelf location based on the acquired image;
comparing the remaining number of the product at the assigned shelf location to a predetermined restocking level for the product; and
generating a restocking alert if the remaining number of the product at the assigned shelf location is less than the predetermined restocking level for the product.

12. The program product of claim 11, wherein the program code for determining a remaining number of the product at the assigned shelf location further comprises program code for:
comparing the acquired image to an empty shelf image of the assigned shelf location.

13. The program product of claim 11, wherein the image of a current state of a product at an assigned shelf location is acquired using a pan-tilt-zoom (PTZ) video camera.

14. The program product of claim 11, further comprising program code for:
periodically repeating the acquiring, determining, and comparing; and
generating a restocking alert whenever the remaining number of the product at the assigned shelf location is less than the predetermined restocking level for the product.

15. The program product of claim 11, wherein there are a plurality of different products, each including an assigned shelf location, further comprising program code for:
obtaining a product map detailing the assigned shelf location of each of the plurality of different products;
performing the acquiring, determining, and comparing for each of the plurality of different products; and
generating a restocking report detailing which of the plurality of different products need to be restocked.

16. The program product of claim 11, wherein the assigned shelf location of the product is located in a retail store.

17. A retail store, comprising:
a plurality of different products, wherein each of the plurality of different products has an assigned shelf location within the retail store; and
a system for determining a restocking state of each of the plurality of different products, the system for determining comprising:
a system for acquiring an image of a current state of the product at its assigned shelf location;
a system for determining a remaining number of the product at the assigned shelf location based on the acquired image;
a system for comparing the remaining number of the product at the assigned shelf location to a predetermined restocking level for the product; and
a system for generating a restocking alert if the remaining number of the product at the assigned shelf location is less than the predetermined restocking level for the product.

18. The retail store of claim 17, wherein the system for determining a remaining number of the product at the assigned shelf location further comprises:
a system for comparing the acquired image to an empty shelf image of the assigned shelf location.

19. A method for deploying an application for determining a restocking state of a product, comprising:
providing a computer infrastructure being operable to:
acquire an image of a current state of a product at an assigned shelf location;
determine a remaining number of the product at the assigned shelf location based on the acquired image;
compare the remaining number of the product at the assigned shelf location to a predetermined restocking level for the product; and
generate a restocking alert if the remaining number of the product at the assigned shelf location is less than the predetermined restocking level for the product.
